(19) United States
(12) Patent Application Publication
(10) Pub. No.: US 2004/0051313 A1
(43) Pub. Date: Mar. 18, 2004

(54) Feed pipe coupling for a pressurised fluid system

(76) Inventor: Remi Trouyet, Dommartin (FR)

Correspondence Address: LINIAK, BERENATO & WHITE, Suite 240, 6550 Rock Spring Drive, Bethesda, MD, 20817, US

(21) Appl. No.: 10/611,676

(22) Filed: Jul. 2, 2003

(30) Foreign Application Priority Data
Aug. 20, 2002 (FR) 02 10289

(51) Int. Cl. F16L 37/00

(52) U.S. Cl. 285/305

(57) ABSTRACT

The invention proposes a feed pipe coupling for a pressurised fluid system, characterised in that the branch of the spring clip which includes the locking portion is configured generally as a hairpin having a radially internal, locking, first branch portion of which the locking portion is a part, together with a radially external, connecting, second branch portion which is connected at each of its ends, firstly to the operational locking branch portion through a bent connecting portion, and, secondly to the central connecting branch of the spring clip, in such a way as to give the locking branch a capacity for elastic deformation in the general transverse plane of the spring clip.

### FIELD OF THE INVENTION

This invention relates to feed pipe couplings for pressurised fluid systems, especially for application to a motor vehicle. More particularly, the invention relates to a feed pipe coupling for a pressurised fluid system, of the type in which a connector has a head which is adapted to be received axially in a body of a feed inlet, and of a type in which the connector is adapted to be locked in a forward position in which it is engaged axially in the feed inlet body by locking means.

### BACKGROUND OF THE INVENTION

It is known to make use of couplings of the above type, also referred to as releasable couplings, in order to enable a feed pipe to be connected in a simple and inexpensive way on the inlet of an item of hydraulic equipment. Such a feed pipe connector for a pressurised fluid system is for example known from the document FR-A-2 736 136.

That document describes, more particularly, a coupling of the type in which a connector is adapted to be held in a position in which it is engaged, axially within the feed inlet of a receiver device, by retaining means, and in which there are arranged, firstly a purging port for the receiver device, and secondly a sealing ring which is fitted between the head of the connector and the feed inlet, the connector obturating the purging port sealingly in the engaged position which is called the locking position, and being able to occupy a position in which it is partially retracted axially towards the rear, referred to as a purging position, in which it is held by retaining means and in which the feed inlet is put into communication sealingly with the purging port.

It is known from the said document to provide retaining means which consist of a spring clip having two branches forming a U, which is engaged transversely in the body of the feed inlet in such a way as to cooperate with an annular radial groove formed in the outer cylindrical surface of the connector.

More precisely, each branch of the spring clip has a first cylindrical portion and a second cylindrical portion of larger diameter, the first cylindrical portion being in cooperation with a posterior first groove or an anterior second groove, these grooves being formed in the connector so as to ensure its retention in the respective locking and purging positions.

The second portion, having the larger diameter, enables the connector to move from the locking position to the purging position. More precisely, operation of the coupling will be explained below.

Firstly, in order to put the coupling into operation, that is to say into its locked position, the operator must proceed in the following sequence:

the connector is introduced into the body until it is fully advanced into its forward axial position, and

the spring clip is then engaged transversely in the body until the first cylindrical portion of the spring clip positions itself in an annular posterior first groove of the connector.

The coupling is not easy to connect in its locking position by the operator, because it is necessary that the posterior first groove be in axial coincidence with the locking means.

Then, when the operator desires to put the coupling into its purging position, the operator has to exert, in succession:

firstly, a first pulling force on the spring clip in order to cause it to be withdrawn partially out of the body in straight line movement, up to a point at which the second cylindrical portion, having the larger diameter, is positioned in axial coincidence with the connector whereby to permit axial removal towards the rear, and

secondly, a second rearward pulling force on the connector.

The locking means are then in an unlocked position. As will be understood, the axial rearward removal of the connector in order to pass from the locking position to the purging position is only possible if the second cylindrical portion having the larger diameter is correctly positioned, that is to say it is in perfect axial coincidence with the connector. Now, since the operator is in no way able to exert visual control to obtain good positioning, he is obliged to feel his way, which is not satisfactory for various reasons.

Among these reasons may be mentioned the length of time which can be necessary for an operator to reach the purging position, and this is not compatible with production requirements, especially in the case where these fitting operations are carried out on motor vehicle production lines on which each operation must be as quick as possible.

These problems do of course occur as much to an operator during the initial fitting operation as, later on, during maintenance operations on the vehicle.

However, the steps just described constitute only the first series of operations to be carried out by the operator before purging can be carried out. In this connection, when the operator has reached the position of having correctly located the second cylindrical portion, and can therefore axially disengage the connector towards the rear, it is still not possible for him to carry out the purging operation because he must first absolutely perform a second set of operations.

This second set of operations consists, in particular, in the operator reengaging the spring clip transversely in order to ensure that the connector is held, that is to say repositioning the first cylindrical portion in the anterior groove corresponding to the purging position. Now here again, this operation is only possible if the connector, and therefore the anterior groove, is correctly positioned with respect to the spring clip.

Apart from the fact that this second set of operations on the coupling has the same disadvantages as before, it does, more importantly, give rise to an additional safety problem.

A purging operation is necessary in order to expel any gases such as air which have been able to penetrate into the coupling, and more particularly into the hydraulic equipment such as a receiver, so as to guarantee proper subsequent operation of the apparatus.

To this end, the operator proceeds to purging the system, that is to say he causes a fluid under pressure to circulate within the hydraulic equipment, for example by creating a reduction in pressure. However, it is absolutely necessary firs,t to have re-engaged the spring clip in such a way that the first cylindrical portion is correctly positioned. Failing that, retention of the connector is not guaranteed, and under the action of the pressure in the fluid the connector runs the risk of being expelled violently out of the feed inlet body.

French patent application FR-A-2 820 489 of the Company Valeo Embrayages discloses a first improvement to such locking means.

In that document, unlocking between the connector and the body, with a view to permitting at least partial rearward axial separation of the connector out of the body, is obtained by elastic deformation of the locking means, and this elastic deformation results from the mating cooperation that occurs between a part of the locking means and a part of the body under the action of a pushing release force which is exerted in a transverse direction on the connecting portion of the branches of the locking means.

In such an arrangement, the locking portion repositions itself automatically in the locking position once the operator has ceased to exert the release force, such as thumb pressure, on the connecting portion, so that the connection is more certain.

The reliability of such locking means is however not satisfactory.

In this connection, it has been possible to establish, after successive manipulations of the locking means or after they have been positioned on the feed inlet body, that in spite of the elasticity of the branches, the latter keep a residual deformation such that locking cannot be guaranteed in a sure and certain manner.

There is therefore a risk that the locking portion will not correctly reposition itself in the groove of the head of the connector, which, because of the fluid flowing under pressure in the feed pipe coupling, renders the locking effect not as reliable as is desirable.

Reliability in operation of such a coupling must be guaranteed for obvious safety reasons. Without that, the main risk encountered is expulsion of the connector out of the body under the action of the pressure in the fluid.

When the operator exerts a pushing force on the connecting portion of the locking means, with a view to causing the transverse branches to move apart by mating cooperation with ramp means which form part of the body, the mechanical stresses undergone by the locking means are mainly localised in the bent portions which join the connecting portion to the transverse branches. These stresses give rise to residual deformation of the locking means, which is not entirely compensated for by their inherent elasticity, and this gives rise to the risk, as soon as the transverse branches are open too far radially outwards, that the locking portion will no longer be able reliably to ensure retention of the head of the connector in the body.

### DISCUSSION OF THE INVENTION

An object of the present invention is to propose a feed pipe coupling of the type discussed above which, in particular, enables the disadvantages which have just been set forth to be remedied.

With this in view, the invention proposes a feed pipe coupling for a pressurised fluid system, of the type in which a connector includes a head which is adapted to be received axially in a body of a feed inlet, and of the type in which the connector is arranged to be locked in a forward position in which it is engaged axially in the body of the feed inlet by at least one locking spring clip having a generally U-shaped form comprising two branches which are generally parallel to each other and oriented generally transversely, at right angles to the axis, together with a central connecting branch, wherein at least one of the transverse branches includes a locking portion which is received at least partly in a radial groove in the head of the connector, characterised in that the branch of the spring clip that has the locking portion is configured in the general form of a hairpin and includes a radially internal, locking, first branch portion, of which the locking portion is a part, together with a radially external, connecting, second branch portion which is connected at each of its ends, firstly to the operational locking branch portion through a bent connecting portion, and secondly, to the central connecting branch of the spring clip, whereby to confer on the locking branch a capacity for elastic deformation in the general transverse plane of the spring clip.

Preferably, this geometry, with two branch portions of at least one of the branches of the spring clip, enables the stresses to be better distributed during its elastic deformation, and the stress level to be reduced. More precisely, the stresses are distributed essentially between the bent portion which joins the locking and connecting branch portions together, and the central connecting branch which joins the connecting branch portions together, and no longer at the level of a single bent portion joining the connecting portion to the two branches.

Thanks to the invention, the spring clip is more reliable and any risk of permanent residual deformation is removed, while preserving a spring clip which is small in size and inexpensive to make.

Preferably, the transverse release force necessary is limited to a weak pushing force, such as the operator's thumb pressure, which must be applied on the central connecting branch of the spring clip in order to cause elastic deformation to take place. In another version, in structural inversion, the transverse release force is a pulling force exerted on the central connecting branch.

Preferably, the friction between the spring clip and the body takes place on the outer surfaces of the body so that no damage to the working surfaces of the body is likely to occur over time after repeated manoeuvres of the spring clip. In this way for example, the internal bore which plays a part in the guiding and sealing functions is preserved.

According to further features of the invention:

the spring clip has a general symmetry of design with relation to a bisecting axial plane which is at right angles to the general plane of the spring clip;

unlocking between the connector and body, with a view to permitting at least partial rearward axial disengagement of the connector out of the body, is obtained by elastic deformation of the branches of the spring clip resulting from mating cooperation between at least a part of the locking branch portion of each branch and at least a portion of the body, under the action of a release force which is applied in a transverse direction on the central connecting branch of the spring clip;

the elastic deformation of the branches of the spring clip causes radial outward displacement of the locking branch portion in a direction substantially at right angles to he said branch portion;

the transverse release force exerted on the central connecting branch is a tractive force;

the transverse release force exerted on the central connecting portion is a thrust force;

the body includes, in facing relationship with the central connecting branch stop means for limiting the displacement of the spring clip during application of the transverse release force;

the locking portion is configured generally as an arc of a circle, the concavity of which is oriented towards the axis in such a way as to cooperate with a frusto-conical portion of the head of the connector during its axial introduction into the body;

the spring clip is mounted on the body, in such a way that it cannot be lost, by stop means included in the body, which cooperate with the free end of at least one of the locking branch portions;

the body has a seating, the abutment base of which lies facing the free end of the locking branch portion, the seating being open laterally for engagement of the said end in the seating during fitting of the spring clip on the body;

the seating is formed in a portion which projects with respect to the outer surface of the body, whereby to permit access to the free end of the locking branch portion for its extraction out of the seating with a view to taking out the spring clip, in particular with the aid of a tool.

The invention also proposes a coupling of the type in which the body of the feed inlet includes a purging port, and of the type in which at least one sealing ring is arranged between the head of the connector and the feed inlet, characterised in that in the engaged position, the connector obturates the purging port sealingly, and in that the connector is able to occupy a position in which it is retracted partially axially towards the rear, and in which the feed inlet is put into communication sealingly with the purging port.

Further features and advantages of the invention will appear on a reading of the following detailed description, for an understanding of which reference will be made to the attached drawings, in which:

### BRIEF DESCRIPTION OF THE DRAWINGS

FIG. 1 is an exploded perspective view of three main components of a coupling in accordance with the features of the invention;

FIGS. 2A and 2B are, respectively, a view in transverse cross section taken on the central radial plane of the spring clip, and a view in perspective of a coupling in accordance with FIG. 1; in FIGS. 2A and 2B the spring clip is mounted on the body and the head of the connector is shown outside the body, that is to say in its position prior to being moved forward in order to establish the connection, or again in the position that results from disconnection of the connector from the body;

FIGS. 3A and 3B are views, respectively, in axial cross section and in perspective with the body cut away, of a coupling according to FIG. 1; FIGS. 3A and 3B show the elastic deformation of the branches of the spring clip which causes radial outward displacement of the locking branch portion when, the head of the connector being introduced partially into the body, the locking portion of the locking branch portion is in cooperation with a frusto-conical portion of the head of the connector;

FIGS. 4A and 4B are views, respectively, in axial cross section and in perspective with the body cut away, of a coupling according to FIG. 1 showing the coupling in a first position or so-called locking or working position, in which the head of the connector is engaged in the body and held by the locking portion of the locking branch portion of the spring clip which is received in a groove in the head of the connector;

FIGS. 5A, 5B and 5C are views in perspective, in transverse cross section and in cut-away perspective respectively, of the body of a coupling, showing the passage from the first or working position to a second position which is a so-called intermediate or purging position, in which the head of the connector is held by the spring clip in an intermediate position, partly retracted towards the rear in the body after a releasing force has been applied on the central connecting portion of the spring clip and a pulling force has been exerted on the connector;

FIGS. 6A and 6B are views in partly cut-away perspective and in transverse cross section respectively, of the body of a coupling; FIGS. 6A and 6B show, by contrast with FIGS. 5A to 5C, the passage from the second position, referred to as the intermediate or purging position, to the first or working position by application of a releasing force on the central connecting portion of the spring clip and an axial forward pushing force on the connector.

### DESCRIPTION OF A PREFERRED EMBODIMENT OF THE INVENTION

In the following description, in order to facilitate understanding, the expressions vertical, horizontal, anterior, posterior, left, right etc. will be used with reference to the Figures and in accordance with the definitions given in the description, but this is not to be taken as limiting.

In the description, those elements which are identical, similar or analogous to each other will be designated by the same reference signs.

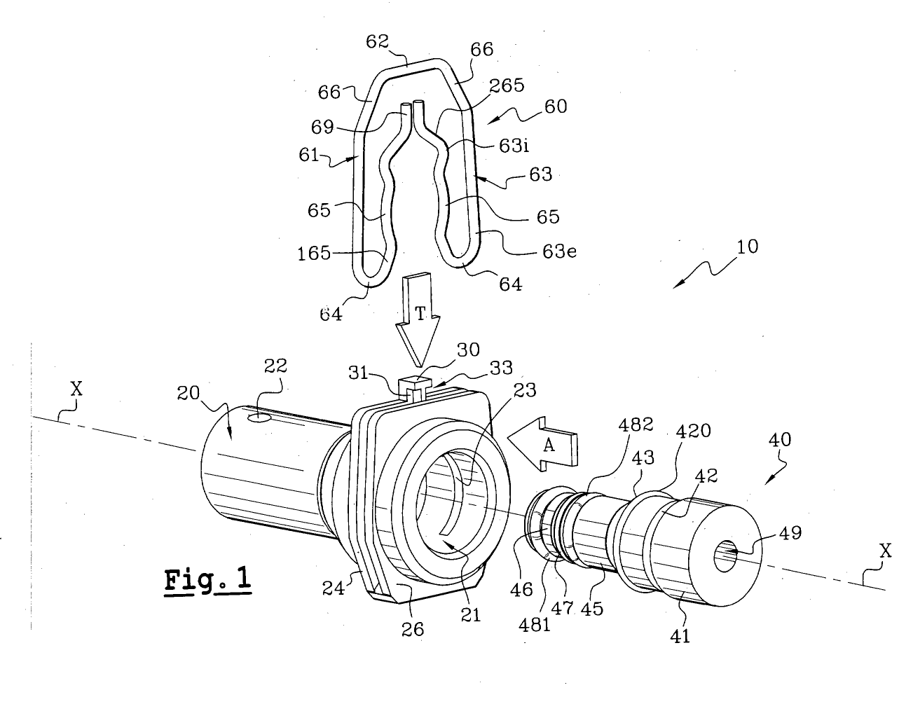

The feed pipe coupling for a pressurised fluid system, which is shown in FIGS. 1 to 6, consists essentially of: an anterior body 20 of a feed inlet 21, which in this example is substantially tubular on the axis X, and which may be fixed with respect to an hydraulic device such as an emitter or a receiver (not shown); a posterior connector 40 which is arranged to be fixed to the end of a feed pipe (not shown); and locking means 60 interposed between the connector 40 and body 20 so as to secure them together.

It is chosen to describe the coupling 10 here in the case in which the connector 40 is movable with respect to the feed inlet 21, but it is of course possible, in another version and without departing from the scope of the invention, to reverse the structures so as to give a coupling 10 in which, on the one hand the connector 50 is fixed and on the other hand, the body 20 of the feed inlet 21 is connected on the end of a pipe such as a flexible or semi-rigid pipe, so that this pipe is thereby indirectly connected to the hydraulic equipment.

FIG. 1 is an exploded perspective view of the three main components of a feed pipe coupling 10 according to the invention for a pressurised fluid system, and more precisely its three main components, that is to say the coupling 10 is of the type in which the posterior connector 40 includes an anterior head which is arranged to be received axially in the body 20 of the feed inlet 21, and of the type in which the connector 40 is adapted to be locked in an anterior position in which it is engaged axially in the body 20 by locking means such as a locking spring clip 60, the said components 20, 40, 60 each being described in greater detail later herein.

The body 20 of the feed inlet 21 in this example is fixed at its front end to a hydraulic receiver (not shown), and includes essentially, considered from front to rear, preferably, a purging port 22, and then a working part which is adapted to receive and cooperate with the locking spring clip 60, and finally, at its free posterior end, the mouth of the feed inlet 21.

According to the type of feed pipe coupling, the body 20 may not have such a purging port 22, but this is not the case where the coupling is for use in a pressurised fluid system such as that illustrated for example in the document FR-A-2 736 136, that is to say a coupling having two positions, namely a locking and a purging position respectively.

The locking spring clip 20 according to the invention is not of course limited to application in such a coupling, but could just as well be used for effecting simple locking, that is to say in a single locking position between two elements such as a body 20 of a feed inlet 21 and a connector 40.

The possibility of using such a locking spring clip 60 for different feed pipe couplings is of particular advantage, for the spring clip can then be produced in large quantities, giving the benefit of a reduction in its cost.

The purging port 22 in this example is made in the form of a simple purging hole which is drilled radially into the body 20 of the feed inlet 21, and thus puts the feed inlet into communication with the outside of the body 20.

In another version (not shown) the purging port is made in the form of a “chimney”, the radially outer end of which preferably includes retaining means such as a bead, adapted to hold a pipe which is attached to it during purging of the pressurised fluid system.

The working part of the body 20 has a transverse slot 23 which is delimited axially and generally symmetrically by two radial plate elements, namely an anterior element 24 and a posterior element 26, which in this example are made integral with the body 20 and which project with respect to the outer cylindrical surface of the body 20, at least over part of their circumference.

Thus, when the locking spring clip 60 is mounted in the slot 23 in the body 20, the plate elements 24, 26 protect the locking spring clip 60 from any involuntary external contact, such as shocks, and they play a part in its proper positioning by constituting axial abutment and guide means for the transverse branches 61, 63 of the spring clip 60.

More precisely, the transverse slot 23 is formed in the thickness of the body 20, having at least its major part in the upper part of the body and extending transversely towards its lower portion, so that the slot 23 is open transversely outwards of the body. It is also open towards the inside of the body 20, within the feed inlet 21 as can be seen in FIG. 1.

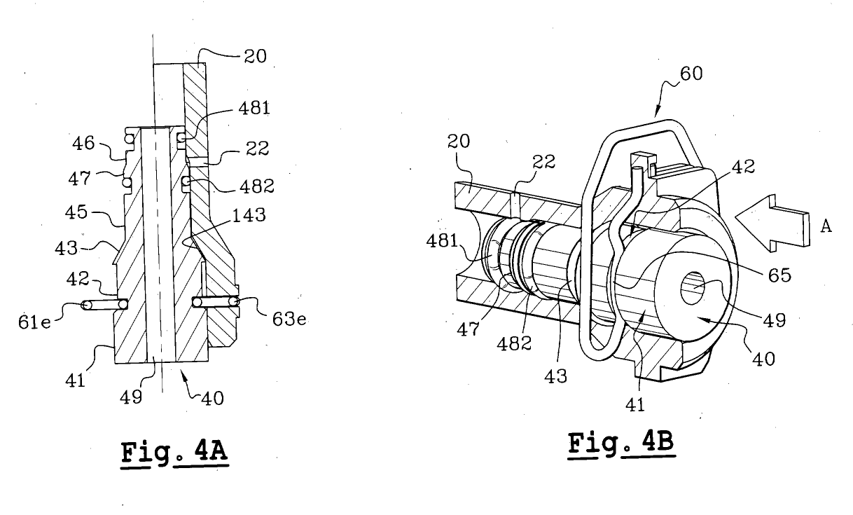

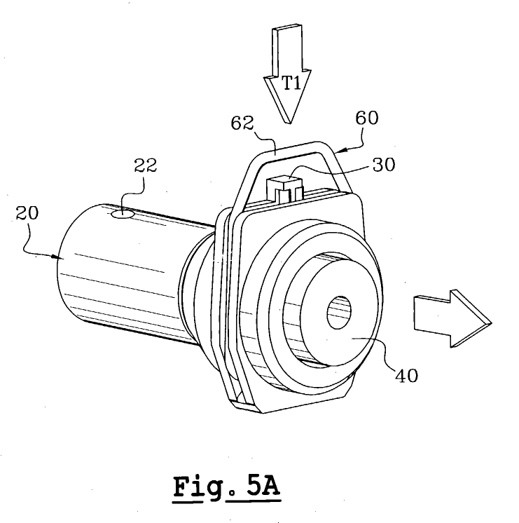

The internal profile of the body 20 of the feed inlet 21 is a stepped profile of revolution having a plurality of portions which are complementary with those of the head of the connector 40, as can be seen more particularly in FIGS. 4A and 4B, and which play a part in guiding the head of the connector 40 into the feed inlet 21.

The head of the connector 40 comprises the following, generally considered from front to rear: a cylindrical anterior first portion 46; an intermediate cylindrical second portion 45 of larger diameter than the anterior cylindrical first portion 46 and connected to this first portion through a frusto-conical portion 47; and a cylindrical rear portion 41 of larger diameter than the intermediate cylindrical portion 45 and connected to the latter through a frusto-conical portion 43.

The complementary internal profile of the body 20 of the feed inlet 21 therefore comprises, considered in succession from front to rear: a cylindrical first portion 146, the form of which is complementary to that of the cylindrical anterior portion 46; a frusto-conical portion 147, the form of which is complementary to that of the frusto-conical portion 47; a cylindrical intermediate portion 145, the form of which is complementary to the cylindrical intermediate portion 45; a frusto-conical portion 143, the form of which is complementary to the frusto-conical portion 43; and a cylindrical posterior portion 141, the form of which is complementary to the cylindrical posterior portion 41.

The body 20 preferably includes stop means 30 for limiting the displacement of the locking spring clip 60 during application of the transverse releasing force.

As regards the head of the connector 40, the anterior cylindrical portion 46 has an annular groove in which there is received a first sealing means such as a sealing ring 481, and the cylindrical intermediate portion 45 includes, at the front in its portion next to the frusto-conical portion 47, a further annular groove in which a second sealing means, in this case a sealing ring 482, is received.

Depending on the particular embodiment, the head of the connector may include one or more sealing means 481, 482. As shown in FIG. 1, the head of the connector 40 in the present case has two sealing rings 481, 482, which correspond to one of the possible versions of a coupling having two positions, namely a locking position and a purging position, whereby to ensure, firstly in the purging position, posterior sealing of the purging port 22 by virtue of the second ring 482 which is in cooperation with the wall of the cylindrical portion 145 of the body 20, and secondly in the working position, anterior and posterior sealing on either side of the purging port 22.

The posterior cylindrical portion 41 includes an annular groove 42 which is arranged to receive, in the working position, at least partly, one of the transverse branches 61, 63 of the spring clip 60, and more precisely the locking portion 65 of one or other, or both, of the said branches.

In its junction zone with the posterior cylindrical portion 41, the frusto-conical portion 43 has an outer diameter which is greater than that of the portion 51, so that the frusto-conical portion 43 has an axially posterior radial shoulder 420 defined by the face of the frusto-conical portion 43 which extends generally at right angles with respect to the cylindrical portion 41.

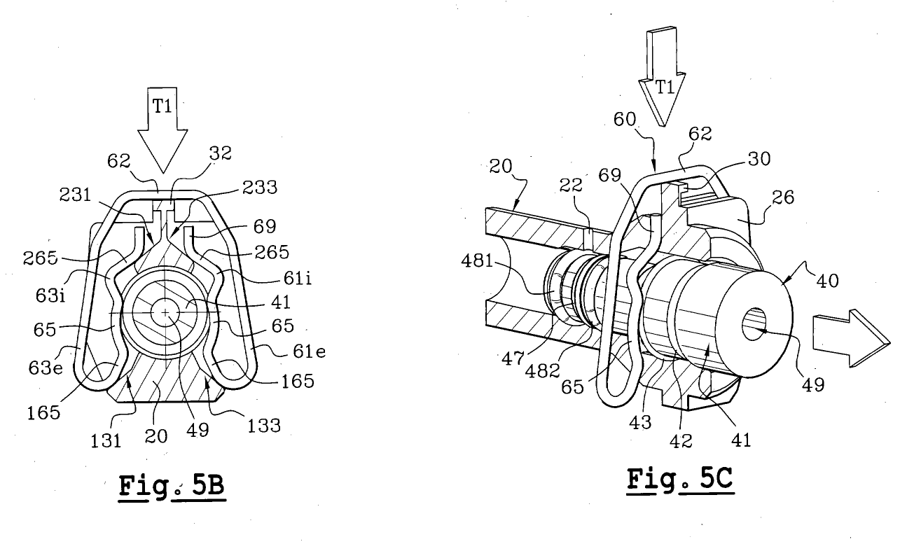

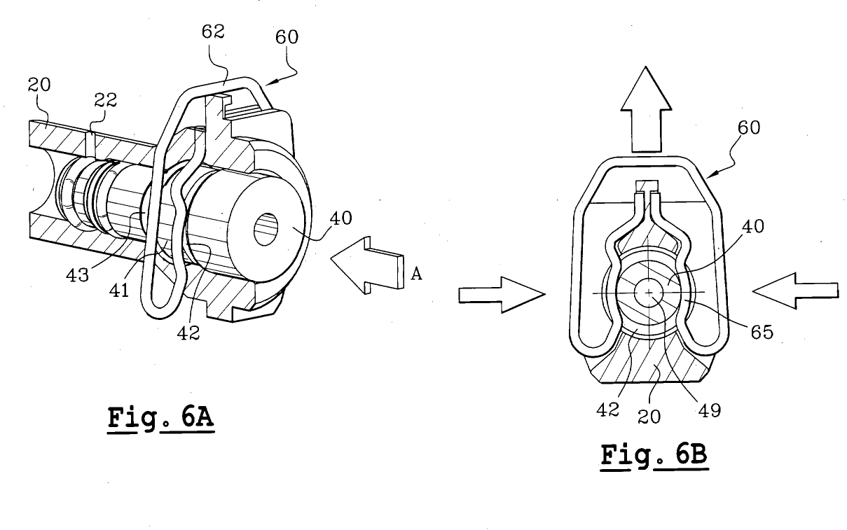

This radial shoulder 420 is arranged for cooperation, in particular, with the locking portion 65 of the branches of the spring clip 60 when the head of the coupling 40 is only partially introduced axially forward into the feed inlet 21, that is to say into the purging position as shown in FIGS. 5C and 6A, and the locking portion 65 is then in engagement against the face 420 and thereby prevents any severe recoil or retraction of the head of the connector 40, in particular under the effect of the pressure in the fluid.

The connector 40 has an internal passage 49 which is open at the anterior axial end of the head, and through which the fluid can flow under pressure from the pipe fixed to the head of the connector 40 towards the feed inlet 21, or vice versa.

The locking spring clip 60 in this example is generally U-shaped, comprising two branches 61, 53 which are generally parallel to each other and oriented generally transversely, at right angles to the axis X, together with a central connecting branch 62, with at least one of the transverse branches 61, 63 including a locking portion 65 which is received axially at least partly within the radial groove 42 in the head of the connector 40.

The locking portion 65 in this example is configured generally as an arc of a circle, the concavity of which is turned towards the axis X in such a way as to cooperate, firstly, with the frusto-conical portion 43 of the head of the connector 40 during its axial forward introduction into the body 20, and secondly, with the annular groove 42 in the head of the connector 40 in the locking position.

Each transverse branch 61, 63 has a particular profile which is adapted to cooperate, firstly, with the body 20, and secondly with the head of the connector 40.

The locking spring clip 60 in this example is in the form of an elastically deformable wire spring. In the embodiments shown in the drawings, the locking spring clip 60 has two transverse branches 61, 63 which are preferably symmetrical with respect to the bisecting axial plane PAM of the spring clip. This symmetry enables the spring clip 60 to have improved general mechanical strength.

Due to this symmetry, the description given below for the transverse branch 63 also applies in the same way to the transverse branch 61.

Thus, in accordance with the invention, the transverse branch 63 of the spring clip 60 which includes the locking portion 65 is configured in the general form of a hairpin, including a radially internal, first branch portion, or locking branch portion, 63i, of which the locking portion 65 is a part, together with a radially external second or connecting branch portion 63e which is joined at each of its ends, firstly to the operative locking branch portion 63i through a bent connecting portion 64, and secondly to the central connecting branch 62 of the spring clip 60 through a further bent portion 66.

This particular configuration gives the locking branches 61 and 63 the ability to deform elastically in the general transverse plane of the spring clip 60.

Starting from the middle of the central connecting branch 62 towards the end, free here, of the transverse branch 61, the general profile of the spring clip 60 when the transverse branches 61, 63 are symmetrical therefore comprises, in succession: a first bent portion 66 joining the central connecting branch 62 to the external branch portion 61e which extends transversely, generally in a straight line; and then a second bent portion 64 joining the external branch portion 61e to the operative locking branch portion 61i of which the locking portion 65 is a part, the profile terminating at its free end in an abutment portion 69 which co-operates with the stop means 30 which are part of the body 20.

More precisely, the operative or locking branch portion 61i includes, between the bent portion 66 and the locking portion 65, a first portion 165 and, between the locking portion 65 and the abutment portion 69, a second portion 265.

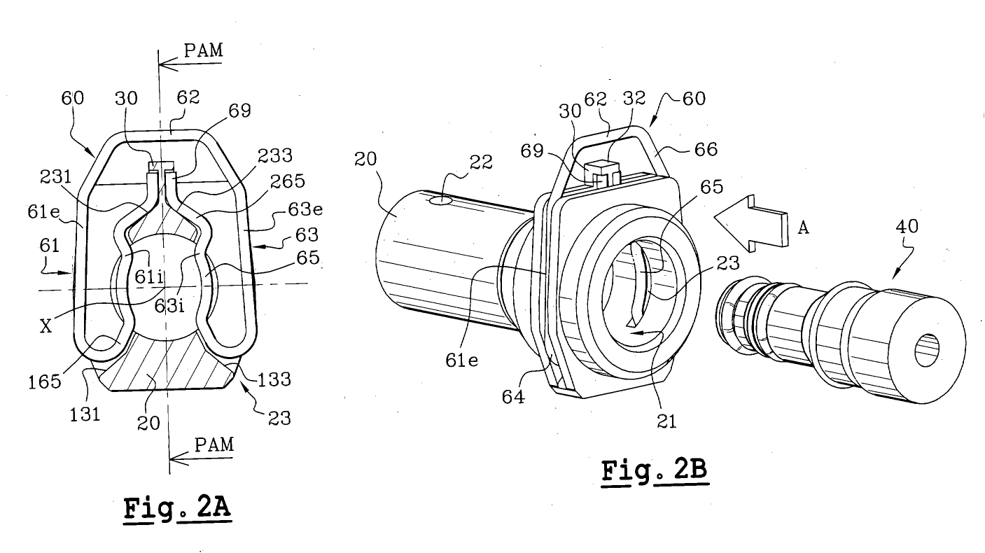

FIG. 2A is a view in transverse cross section taken on the bisecting radial plane of the spring clip 60, illustrating the locking spring clip 60 after it has been introduced into the slot 23 in the body 20.

As is shown in perspective in FIG. 2B, the locking spring clip 60 may be pre-fitted on the body 20, preferably in such a way that it cannot be lost, before the axial forward introduction of the head of the connector 40 into the feed inlet 21.

As can be seen best in FIG. 2A, the complementary portion of the slot 23, that is to say the complementary remaining material of the body 20, defines, in this example, symmetrically with respect to the bisecting radial plane of the spring clip 60, a profile which comprises inclined portions constituting ramps and adapted to cooperate with the first and second portions 165, 265 of each of the lateral branches 61, 63 of the locking spring clip 60.

The complementary profile of the slot 23 in the body 20 includes, transversely of the upper part of the body towards its lower part with reference to FIG. 2A: upper portions 231, 233 constituting ramps; an aperture defined by the slot 23 and opening into the feed inlet 21, with the locking portion 65 of the spring clip 60 penetrating into the said aperture; and lower portions 131, 133 defining ramps.

The upper ramp portions 231, 233 are thus in cooperation with the first portions 165 of the respective transverse branches 61 and 63, and in the same way the lower ramp portions 131, 133 are in cooperation with the second portions 265 of the respective transverse branches 61 and 63.

The portions 131, 133, 231, 233 constitute control ramps. In this connection, when a release force is applied in the transverse direction T on the connecting branch 62 of the spring clip 60 as shown in FIGS. 5A and 5B, an elastic deformation of the branches 61, 63 of the spring clip results from the mating cooperation that then occurs between the respective portions 131, 133, 231, 233 of the body 20 and the corresponding portions 165, 265 of the branches 61, 63 of the spring clip, thereby causing radial outward displacement of the locking branch portion 61i, 63i in a direction substantially at right angles to that branch portion.

As can be seen in FIG. 2A, the portions 131, 133, 231, 233 have in this example a substantially straight inclined profile to define the control ramps, though in another version the portions 131, 133 may have a generally V-shaped profile, that is to say a boss projecting radially inwards from the feed inlet 21.

Such a boss preferably constitutes, by mating cooperation with the spring clip 60, a brake against any unwanted retraction of the spring clip 60 out of the slot 23 of the body 20 in the direction away from the direction of its introduction in the transverse direction T.

Such a brake constitutes an alternative to the means for securing against loss constituted by the stop means 30 which will now be described in detail. This stop means is carried on the body 20 in facing relationship with the central connecting branch 62. The stop means 30 limits the displacement of the spring clip during application of the transverse release force on the central connecting branch 62, in this case a pushing force in the preferred embodiment shown in the drawings.

As can be seen in FIG. 2A, the stop means 30 in this example are constituted by a portion which extends radially outwards from the plate elements 24, 26, having, in transverse cross section, a general T shape which comprises an axially oriented bar and a radially oriented bar. The abutment means 30 consist of the upper surface 32 of the axially oriented bar, against which the connecting branch 62 comes into contact once a sufficiently large release force is applied.

The body 20 includes, in the present case in the stop means 30 itself, two seatings 31, 33, the abutment base of each of which lies facing the free end, that is to say the portions 69, of each of the locking branch portions 61i , 63i. Each of these seatings is open laterally towards the rear for engagement of the said abutment portions 69 in their respective seatings during fitting of the spring clip 60 on the body 20.

More precisely, in transverse cross section as seen in FIG. 2A, the seating is defined on either side of the transversely oriented bar of the T for the two respective locking branch portions 61i, 63i, by the intersection of the transverse bar with the axial bar in such a way that the abutment base is defined, for each of the abutment portions 69, by the radially internal surface defined by the axially oriented bar of the T, that is to say it is in opposed relationship to the upper surface 32.

Because of the seatings 31, 33 and the abutment base which they include, the locking spring clip 60 is mounted on the body 20 in such a way that it cannot be lost. In this connection, once it has been fitted, the spring clip 60 remains fixed with respect to the body 20 even if a traction force is exerted on the connecting branch 62, because the abutment portions 69 of the branch portions 61i, 63i then come into abutment against the abutment bases of their respective seatings 31, 33.

Nevertheless, since the stop means 30 in this case are formed so as to project with respect to the outer surface of the body 20, it is possible to gain access to the seatings 31, 33, and therefore to the abutment portions 69 of the branch portions, in such a way as to be able, in particular with the aid of a tool, to proceed at will to extract them out of the seating and therefore to take out the spring clip 60.

Such a tool may for example consist of a pair of pliers, the ends of which, inserted between the transverse wall constituted by the transversely oriented bar of the T and the portions 69, would, when moved apart, cause a sufficiently large lateral displacement of the portions 69 out of the seatings 31, 33.

As shown in FIGS. 2A and 2B, the spring clip 60 may with advantage be pre-fitted into the slot 23 in the body 20 in the locking position, the head of the connector 40 being then force-fitted into the feed inlet 21 of the body 20.

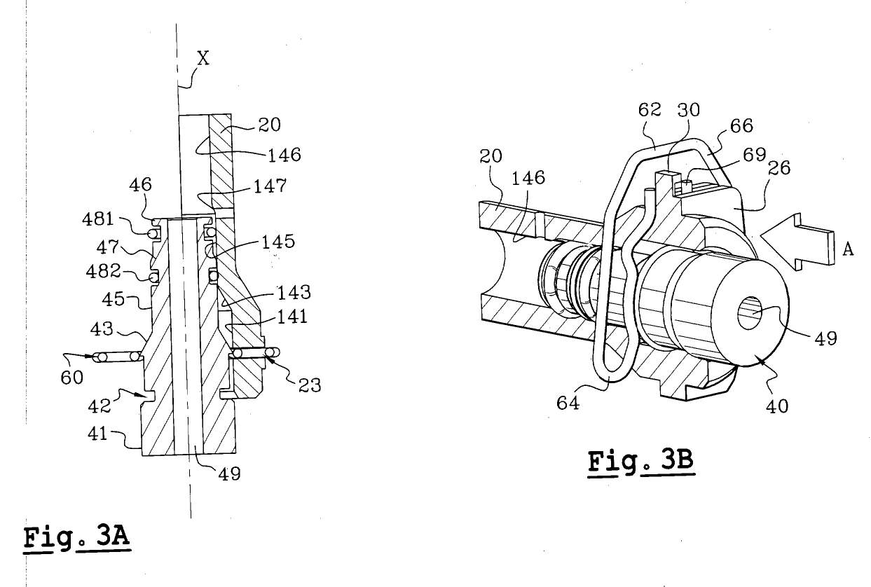

When the head of the body 40 is engaged axially in the direction A in such a force-fitting operation, illustrated by FIGS. 3A and 3B, it is not necessary to exert a release force on the central connecting branch 62. In this connection, this fitting is made possible in this action on the spring clip 60 because the transverse branches 61, 63 of the spring clip 60, and more precisely the locking portions 65 which are generally in the form of an arc of a circle, of each of the locking branch portions 61i, 63i, will deform elastically under the action of the frusto-conical intermediate portion 43 of the head of the connector 40, which causes outward radial displacement of the locking branch portions 61i, 63i out of the slot 23.

It will be noted that once they have passed the frusto-conical intermediate portion 43, the transverse branches 61, 63 will, under the effect of elastic return force, automatically be repositioned in such a way that the locking portions 65 of the locking branch portions 61i, 63i cooperate with the posterior cylindrical portion 41 of the connector.

From then on it is no longer possible to disengage the head of the connector 40 out of the feed inlet 21 of the body 20, for example by exerting a pulling force on the connector 40, and in this connection the locking portions 65 would then come into engagement against the radial shoulder 420 of the frusto-conical portion 43, thereby limiting any rearward displacement of the connector 40 with respect to the body 20.

The operation of the feed pipe coupling 10 will be understood more clearly on a reading of the following description of the Figures of the drawings which illustrate the various steps for such a coupling having two positions, namely a working position and a purging position respectively.

Preferably, the coupling 10 in this example has only one locking spring clip 60, though in another version it may have two locking spring clips, each for a respective one of the locking and purging positions of the connector 40 and the body 20.

The purging system 22, in particular, permits expulsion from the feed pipe coupling 10 of any gas which may have been introduced or trapped therein, such as air, and which is liable to be detrimental, to proper operation of the coupling.

FIGS. 4A and 4B show the coupling in its locking position, this position being obtained when axial forward engagement of the head of the coupling 40 is pursued into the body 20 of the feed inlet 21 shown in the foregoing FIGS. 3A and 3B.

In this so-called locking position, the head of the connector 40 is completely engaged in the feed inlet 21 of the body 20, and is maintained in position axially, in both the forward and the backward directions, by the locking portions 65 of the locking branch portions 61i, 63i of the spring clip 60 which are received in the annular groove 42 formed in the cylindrical rear portion 41 of the head of the connector 40.

In the locking position of the connector 40, the various stepped portions, cylindrical and frusto-conical, of the internal profile of the body 20 of the feed inlet 20 and the head of the connector 40 respectively, are in facing relationship with each other.

Thus, the cylindrical first portion 146 of the body 20 in this example is in facing relationship with the cylindrical anterior portion 46 of the connector 40, and in the same way the frusto-conical and cylindrical portions 147, 145, 143 and 141 of the body lie facing towards the respective frusto-conical and cylindrical portions 47, 45, 43 and 41 of the head of the connector 40.

The various stepped portions, cylindrical and frusto-conical, of the connector 40 and body 20 are of course dimensioned axially in such a way that, in the locking position of the connector 40 in the body 20, on the one hand the anterior sealing ring 481 of the head of the connector will be in contact with the cylindrical wall of the portion 146 of the body 20 in front of the purging portion 22, so as to establish sealed communication between the feed pipe fixed to the connector 40 and the feed inlet 21 of the hydraulic equipment, and, on the other hand, the groove 42 into which the locking portions 65 of the branch portions 61i, 63i of the spring clip penetrate at least partly are in coincidence with the slot 23 and therefore with the spring clip 60 itself.

In order to unlock the coupling 10 partially, in particular in order to effect axial rearward displacement of the head of the connector 40 with respect to the body 20, that is to say in order to pass for example from the working position shown in FIGS. 4A and 4B to the purging position shown in FIGS. 5A to 5C, it is necessary on the one hand to exert a release force in the transverse direction T1 on the connecting branch 62 of the spring clip 60, so as to cause the locking branch portions 61i, 63i to move apart radially outwards, and on the other hand, a rearward tractive force on the connector 40.

During this manoeuvre and as can be seen in FIGS. 5B and 5C, the locking branch portions 61i, 63i are displaced radially outwards from the slot 23, in such a way that the locking portions 65 are no longer received in the groove 42. It is then possible to displace the head of the connector 40 axially towards the rear, and the locking portions 65 are in contact with the posterior cylindrical portion 41 until they come into abutment against the shoulder 420 defined at the junction of the said portion 41 and the frusto-conical intermediate portion 43.

The course of travel performed by the central connecting branch 62 before it comes into abutment against the external face 32 of the stop means 30 is of course such that the radial outward displacement of the branch portions 61i, 63i, and particularly the locking portions 65, does not go beyond the outer diameter of the frusto-conical portion 43. Failing that, the connector 40 could be ejected out of the body 20 under the effect of the pressure in the fluid.

More precisely, the radial outward displacement of the locking branch portions 61i, 63i results from the combined action of a releasing thrust force exerted on the central connecting branch 62 and a mating cooperation between, on the one hand, the upper portions 231, 233 constituting control ramps, which cooperate with the first portions 165 of the transverse branches 61 and 63, and, on the other hand, the lower portions 131, 133 constituting control ramps which cooperate with the second portions 265 of the transverse branches 61 and 63.

The release force to be exerted on the spring clip 60 in this example is preferably a pushing force, that is to say a force which is easy for the operator to exert with a simple pressure of the thumb on the connecting branch 62. In another version, the release force to be exerted on the spring clip may be a pulling force, as described for example in Application FR-A-2 736 136.

Once the release force is no longer being exerted on the central connecting branch 62, the outward radial displacement resulting from the elastic deformation of the transverse branches 61, 63 ceases and the locking branch portions 61i, 63i become repositioned in engagement against the shoulder 420 by elastic return in directions opposite to the displacement, the connector 40 then being in the so-called purging position as shown in FIG. 5C.

This automatic repositioning of the locking branch portions 61i, 63i and of their locking portions 65 has the advantage that it provides security for the operator, who does not have to perform any specific action on the spring clip 60 in order to perform the locking operation afresh.

In the purging position, sealing between the head of the connector 40 and the internal wall of the feed inlet 21 is ensured, behind the purging port 22, by the sealing ring 482 which is arranged axially behind the sealing ring 481 and mounted in a groove which is part of the cylindrical portion 45 in the vicinity of the frusto-conical portion 47, the sealing ring 482 being in cooperation with the cylindrical portion 145 of the body 20.

Because of the sealing ring 482, the fluid is unable to be evacuated outwards except through the purging port 22.

In another version, when the cylindrical portions 46 and 45 of the head of the connector 40 are of the same diameter, the frusto-conical portion 47 being omitted, the head of the connector 40 may have only a single sealing ring which provides sealing axially in front of the purging port 22 in the locking position, and axially behind the purging port in the purging position, the internal profile of the body 20 being matched so as to be complementary to that of the connector 40.

Where the locking spring clip has two symmetrical transverse branches 61, 63, the spring clip is then preferably perfectly reversible, so that no particular fitting direction needs to be observed by the operator.

Once the purging operation has been completed, the operator must then, in order to put the connector once more into its locking position, exert an axial forward force on the connector 40 in such a way as to introduce it completely into the feed inlet 21 of the body 20.

During this operation, which is shown in FIGS. 6A and 6B, it is not necessary to manipulate the locking spring clip 60, and in this connection the locking portions 65 of the branch portions 61i, 63i are displaced on the posterior cylindrical portion 41 of the connector 40 until they automatically re-engage in the groove 42 by a simple elastic return effect.

The locking spring clip 60 can of course be made in a different way, and may be either of metal or of a synthetic material, preferably having a toroidal or circular cross section.

The embodiment described and shown here is of course one example of how the invention may be performed.

Other embodiments, not shown, can be envisaged without departing from the scope of the invention.

What is claimed is:

1. A feed pipe coupling for a pressurised fluid system, of the type in which a connector includes a head which is adapted to be received axially in a body of a feed inlet, and of the type in which the connector is arranged to be locked in a forward position in which it is engaged axially in the body of the feed inlet by at least one locking spring clip having a generally U-shaped form comprising two branches which are generally parallel to each other and oriented generally transversely, at right angles to the axis, together with a central connecting branch, wherein at least one of the transverse branches includes a locking portion which is received at least partly in a radial groove in the head of the connector, wherein the branch of the spring clip that has the locking portion is configured in the general form of a hairpin and includes a radially internal, locking, first branch portion, of which the locking portion is a part, together with a radially external, connecting, second branch portion which is connected at each of its ends, firstly to the operational locking branch portion through a bent connecting portion, and secondly, to the central connecting branch of the spring clip, whereby to confer on the locking branch a capacity for elastic deformation in the general transverse plane of the spring clip.

2. A coupling according to claim 1, wherein the spring clip has a general symmetry of design with relation to a bisecting axial plane which is at right angles to the general plane of the spring clip.

3. A coupling according to claim 1, wherein unlocking between the connector and body, with a view to permitting at least partial rearward axial disengagement of the connector out of the body, is obtained by elastic deformation of the branches of the spring clip resulting from mating cooperation between at least a part of the locking branch portion of each branch and at least a portion of the body, under the action of a release force which is applied in a transverse direction on the central connecting branch of the spring clip.

4. A coupling according to claim 3, wherein the elastic deformation of the branches of the spring clip causes radial outward displacement of the locking branch portion in a direction substantially at right angles to the said branch portion.

5. A coupling according to claim 3, wherein the transverse release force exerted on the central connecting branch is a tractive force.

6. A coupling according to claim 3, wherein the transverse release force exerted on the central connecting portion is a thrust force.

7. A coupling according to claim 6, wherein the body includes, in facing relationship with the central connecting branch stop means for limiting the displacement of the spring clip during application of the transverse release force.

8. A coupling according to claim 1, wherein the locking portion is configured generally as an arc of a circle, the concavity of which is oriented towards the axis in such a way as to cooperate with a frusto-conical portion of the head of the connector during its axial introduction into the body.

9. A coupling according to claim 1, wherein the spring clip is mounted on the body, in such a way that it cannot be lost, by means of stop means included in the body, which cooperate with the free end of at least one of the locking branch portions.

10. A coupling according to claim 9, wherein the body has a seating, the abutment base of which lies facing the free end of the locking branch portion, the seating being open laterally for engagement of the said end in the seating during fitting of the spring clip on the body.

11. A coupling according to claim 10, wherein the seating is formed in a portion which projects with respect to the outer surface of the body, whereby to permit access to the free end of the locking branch portion for its extraction out of the seating with a view to taking out the spring clip, in particular with the aid of a tool.

12. A coupling according to claim 1, of the type in which the body of the feed inlet includes a purging port, and of the type in which at least one sealing ring is arranged between the head of the connector and the feed inlet, wherein in the engaged position, the connector obturates the purging port sealingly, and in that the connector is able to occupy a position in which it is retracted partially axially towards the rear, and in which the feed inlet is put into communication sealingly with the purging port.
